(19) United States
(12) Patent Application Publication
(10) Pub. No.: US 2011/0032332 A1
(43) Pub. Date: Feb. 10, 2011

(54) METHOD AND SYSTEM FOR MULTIPLE PROGRESSIVE 3D VIDEO FORMAT CONVERSION

(76) Inventors: Darren Neuman, Palo Alto, CA (US); Xuemin Chen, Rancho Santa Fe, CA (US); Chris Payson, Bolton, MA (US); Jason Herrick, Pleasanton, CA (US); Val (Shawn) Johnson, Rancho Santa Margarita, CA (US)

Correspondence Address: MCANDREWS HELD & MALLOY, LTD, 500 WEST MADISON STREET, SUITE 3400, CHICAGO, IL, 60661, US

(21) Appl. No.: 12/851,084

(22) Filed: Aug. 5, 2010

Related U.S. Application Data
(60) Provisional application No. 61/232,123, filed on Aug. 7, 2009.

(51) Int. Cl. H04N 13/00

(52) U.S. Cl. 348/43; 348/E07.003; 348/E13.062

(57) ABSTRACT

A 3-dimensional (3D) video receiver may be operable to scale a decompressed 3D video frame having a first 3D video progressive format to generate a 3D video frame having a second 3D video progressive format, where the second 3D video progressive format comprises a high-definition multimedia interface (HDMI) format. When operating in an electronic program guide mode or a graphics over video mode, the 3D video frame having the second 3D video progressive format may be blended with graphics. The 3D video frame having the second 3D video progressive format may be converted to generate a 3D video frame having a 3D video interlaced format by performing a pulldown. The 3D video frame having the second 3D video progressive format at a 50 Hz frame rate may be frame-rate upconverted to generate a 3D video frame having a third 3D video progressive format at a 60 Hz frame rate.

### CROSS-REFERENCE TO RELATED APPLICATIONS/INCORPORATION BY REFERENCE

This patent application makes reference to, claims priority to, and claims benefit from U.S. Provisional Application Ser. No. 61/232,123, which was filed on Aug. 7, 2009.

This application also makes reference to:

U.S. patent application Ser. No. ______ (Attorney Docket No. 20914U502) filed on ______; and

U.S. patent application Ser. No. ______ (Attorney Docket No. 23643U502) filed on ______.

Each of the above stated applications is hereby incorporated herein by reference in its entirety.

### FIELD OF THE INVENTION

Certain embodiments of the invention relate to video processing. More specifically, certain embodiments of the invention relate to a method and system for multiple progressive 3D video format conversion.

### BACKGROUND OF THE INVENTION

Digital video capabilities may be incorporated into a wide range of devices such as, for example, digital televisions, digital direct broadcast systems, digital recording devices, and the like. Digital video devices may provide significant improvements over conventional analog video systems in processing and transmitting video sequences with increased bandwidth efficiency.

Video content may be recorded in two-dimensional (2D) format or in three-dimensional (3D) format. In various applications such as, for example, the DVD movies and the digital TV (DTV), a 3D video is often desirable because it is often more realistic to viewers than the 2D counterpart. A 3D video comprises a left view video and a right view video. A 3D video frame may be produced by combining left view video components and right view video components.

Various video encoding standards, for example, MPEG-1, MPEG-2, MPEG-4, H.263, H.264/MPEG-4 advanced video coding (AVC) and multi-view video coding (MVC), have been established for encoding digital video sequences in a compressed manner. For example, the MVC standard, which is an extension of the H.264/MPEG-4 AVC standard, may be used to encode a 3D video.

Most TV broadcasts, and similar multimedia feeds, utilize video formatting standard that enable communication of video images in the form of bitstreams. These video standards may utilize various interpolation and/or rate conversion functions to present content comprising still and/or moving images on display devices. For example, deinterlacing functions may be utilized to convert moving and/or still images to a format that is suitable for certain types of display devices that are unable to handle interlaced content. TV broadcasts, and similar video feeds, may be interlaced or progressive. Interlaced video comprises fields, each of which may be captured at a distinct time interval. A frame may comprise a pair of fields, for example, a top field and a bottom field. The pictures forming the video may comprise a plurality of ordered lines. During one of the time intervals, video content for the even-numbered lines may be captured. During a subsequent time interval, video content for the odd-numbered lines may be captured. The even-numbered lines may be collectively referred to as the top field, while the odd-numbered lines may be collectively referred to as the bottom field. Alternatively, the odd-numbered lines may be collectively referred to as the top field, while the even-numbered lines may be collectively referred to as the bottom field. In the case of progressive video frames, all the lines of the frame may be captured or played in sequence during one time interval. Interlaced video may comprise fields that were converted from progressive frames. For example, a progressive frame may be converted into two interlaced fields by organizing the even numbered lines into one field and the odd numbered lines into another field.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for multiple progressive 3D video format conversion, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating exemplary 3D video formats, in accordance with an embodiment of the invention.

FIG. 2 is a block diagram illustrating an exemplary video communication system that is operable to provide multiple progressive 3D video format conversion, in accordance with an embodiment of the invention.

FIG. 3 is a block diagram illustrating an exemplary STB that operates at 60 Hz to provide multiple progressive 3D video format conversion, in accordance with an embodiment of the invention.

FIG. 4 is an exemplary table that illustrates progressive 3D video format conversion performed by a STB operating at 60 Hz, in accordance with an embodiment of the invention.

FIG. 5 is a block diagram illustrating an exemplary STB that operates at 50 Hz to provide multiple progressive 3D video format conversion, in accordance with an embodiment of the invention.

FIG. 6 is an exemplary table that illustrates progressive 3D video format conversion performed by a STB operating at 50 Hz, in accordance with an embodiment of the invention.

FIG. 7 is a block diagram illustrating an exemplary DTV set that is operable to provide multiple progressive 3D video format conversion, in accordance with an embodiment of the invention.

FIG. 8A is an exemplary table that illustrates progressive 3D video format conversion performed by a DTV set, in accordance with an embodiment of the invention.

FIG. 8B is an exemplary table that illustrates progressive 3D video format conversion performed by a DTV set, in accordance with an embodiment of the invention.

FIG. 9 is a flow chart illustrating exemplary steps for multiple progressive 3D video format conversion, in accordance with an embodiment of the invention.

### DETAILED DESCRIPTION OF THE INVENTION

Certain embodiments of the invention can be found in a method and system for multiple progressive 3D video format conversion. In various embodiments of the invention, a 3-dimensional (3D) video receiver may be operable to scale a decompressed 3D video frame having a first 3D video progressive format to generate a 3D video frame having a second 3D video progressive format. The second 3D video progressive format may comprise a high-definition multimedia interface (HDMI) 3D video format. The second 3D video progressive format may comprise, for example, side-by-side (half) 1080p24 format, side-by-side (half) 720p60 format, side-by-side (half) 720p50 format, top-and-bottom (half) 1080p24 format, top-and-bottom (half) 720p60 format, top-and-bottom (half) 720p50 format, frame packing 1080p24 format, frame packing 720p60 format and/or frame packing 720p50 format.

The 3D video receiver may be operable to determine when the 3D video receiver is operating in an EPG mode or in a graphics over video mode. In instances when the 3D video receiver is operating in the EPG mode or in the graphics over video mode, the generated 3D video frame having the second 3D video progressive format may be blended with graphics by the 3D video receiver. In this regard, in instances when the graphics comprises 3D graphics, a depth of the 3D graphics and/or a depth of the generated 3D video frame having the second 3D video progressive format may be adjusted coordinately by the 3D video receiver for a blended frame to provide better overall depth of the blended frame.

In an exemplary embodiment of the invention, the 3D video receiver may be operable to scale the decompressed 3D video frame having the first 3D video progressive format, which may comprise a 24 Hz frame rate, to generate the 3D video frame having the second 3D video progressive format, which may comprise a 24 Hz frame rate. The generated 3D video frame having the second 3D video progressive format may be further converted by the 3D video receiver to generate a 3D video frame having a 3D video interlaced format by performing a pulldown. In this regard, for example, the generated 3D video frame having the second 3D video progressive format, which may comprise a 24 Hz frame rate, may be converted by the 3D video receiver to generate a 3D video frame having a 3D video interlaced format, which may comprise a 60 Hz field rate, by performing a 3:2 pulldown. The generated 3D video frame having the second 3D video progressive format, which may comprise a 24 Hz frame rate, may be converted by the 3D video receiver to generate a 3D video frame having a 3D video interlaced format, which may comprise a 50 Hz field rate, by performing a 2:2 pulldown.

In an exemplary embodiment of the invention, the 3D video receiver may be operable to scale the decompressed 3D video frame having the first 3D video progressive format, which may comprise a 50 Hz frame rate, to generate the 3D video frame having the second 3D video progressive format, which may comprise a 50 Hz frame rate. The generated 3D video frame having the second 3D video progressive format, which may comprise a 50 Hz frame rate, may be frame-rate upconverted by the 3D video receiver to generate a 3D video frame having a third 3D video progressive format, which may comprise a 60 Hz frame rate.

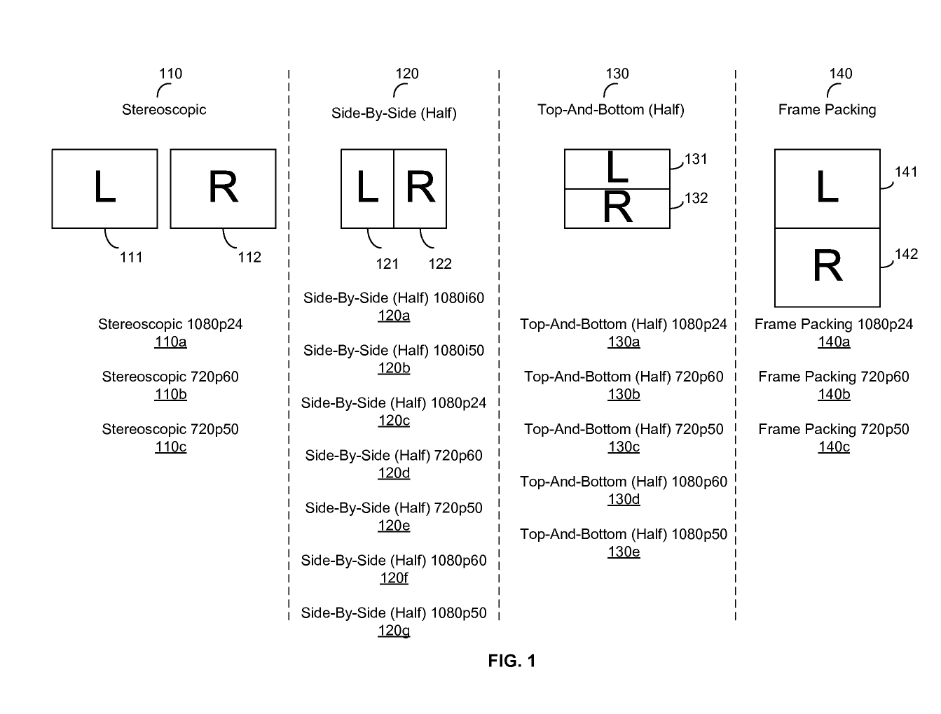

FIG. 1 is a block diagram illustrating exemplary 3D video formats, in accordance with an embodiment of the invention. Referring to FIG. 1, there is shown a stereoscopic format 110, a side-by-side (half) format 120, a top-and-bottom (half) format 130 and a frame packing format 140.

A 3D video in the stereoscopic format 110 may comprise a full resolution left view frame 111 and a full resolution right view frame 112. The stereoscopic format 110 may comprise, for example, stereoscopic 1080p24 format 110a, stereoscopic 720p60 format 110b and/or stereoscopic 720p50 format 110c.

A 3D video in the side-by-side (half) format 120 may comprise a half resolution left view 121 and a half resolution right view 122, which may be packed as side-by-side or left-and-right in a frame. The side-by-side (half) format 120 may comprise, for example, side-by-side (half) 1080i60 format 120a, side-by-side (half) 1080i50 format 120b, side-by-side (half) 1080p24 format 120c, side-by-side (half) 720p60 format 120d, side-by-side (half) 720p50 format 120e, 1080p60 format 120f and/or 1080p50 format 120g.

A 3D video in the top-and-bottom (half) format 130 may comprise a half resolution left view 131 and a half resolution right view 132, which may be packed as top-and-bottom in a frame. The top-and-bottom (half) format 130 may comprise, for example, top-and-bottom (half) 1080p24 format 130a, top-and-bottom (half) 720p60 format 130b, top-and-bottom (half) 720p50 format 130c, top-and-bottom (half) 1080p60 format 130d and/or top-and-bottom (half) 1080p50 format 130e.

A 3D video in the frame packing format 140 may comprise a full resolution left view 141 and a full resolution right view 142, which may be packed as top-and-bottom in a frame with twice the normal bandwidth. The frame packing format 140 is a full resolution top-and-bottom format. The frame packing format 140 may comprise, for example, frame packing 1080p24 format 140a, frame packing 720p60 format 140b and/or frame packing 720p50 format 140c.

A 3D video frame in a 1080i60 format, such as the side-by-side (half) 1080i60 format 120a, may comprise a resolution of 1920×1080 pixels in interlace mode at a 60 Hz field rate. In this regard, for example, a left view 121 or a right view 122 in the side-by-side (half) 1080i60 format 120a may comprise a resolution of 960×1080 pixels. A 3D video frame in a 1080i50 format, such as the side-by-side (half) 1080i50 format 120b, may comprise a resolution of 1920×1080 pixels in interlace mode at a 50 Hz field rate. In this regard, for example, a left view 121 or a right view 122 in the side-by-side (half) 1080i50 format 120b may comprise a resolution of 960×1080 pixels.

A 3D video frame in a 1080p24 format, such as the stereoscopic 1080p24 format 110a, the side-by-side (half) 1080p24 format 120c, the top-and-bottom (half) 1080p24 format 130a or the frame packing 1080p24 format 140a, may comprise a resolution of 1920×1080 pixels in progressive scan mode at a 24 Hz frame rate. In this regard, for example, a left view 121 or a right view 122 in the side-by-side (half) 1080p24 format 120c may comprise a resolution of 960×1080 pixels. A left view 131 or a right view 132 in the top-and-bottom (half) 1080p24 format 130a may comprise a resolution of 1920×540 pixels. A left view 141 or a right view 142 in the frame packing 1080p24 format 140a may comprise a resolution of 1920×1080 pixels.

A 3D video frame in a 1080p60 format, such as the side-by-side (half) 1080p60 format 120f or the top-and-bottom (half) 1080p60 format 130d, may comprise a resolution of 1920×1080 pixels in progressive scan mode at a 60 Hz frame rate. In this regard, for example, a left view 121 or a right view 122 in the side-by-side (half) 1080p60 format 120f may comprise a resolution of 960×1080 pixels. A left view 131 or a right view 132 in the top-and-bottom (half) 1080p60 format 130d may comprise a resolution of 1920×540 pixels.

A 3D video frame in a 1080p50 format, such as the side-by-side (half) 1080p50 format 120g or the top-and-bottom (half) 1080p50 format 130e, may comprise a resolution of 1920×1080 pixels in progressive scan mode at a 50 Hz frame rate. In this regard, for example, a left view 121 or a right view 122 in the side-by-side (half) 1080p50 format 120g may comprise a resolution of 960×1080 pixels. A left view 131 or a right view 132 in the top-and-bottom (half) 1080p50 format 130e may comprise a resolution of 1920×540 pixels.

A 3D video frame in a 720p60 format, such as the stereoscopic 720p60 format 110b, the side-by-side (half) 720p60 format 120d, the top-and-bottom (half) 720p60 format 130b or the frame packing 720p60 format 140b, may comprise a resolution of 1280×720 pixels in progressive scan mode at a 60 Hz frame rate. In this regard, for example, a left view 121 or a right view 122 in the side-by-side (half) 720p60 format 120d may comprise a resolution of 640×720 pixels. A left view 131 or a right view 132 in the top-and-bottom (half) 720p60 format 130b may comprise a resolution of 1280×360 pixels. A left view 141 or a right view 142 in the frame packing 720p60 format 140b may comprise a resolution of 1280×720 pixels.

A 3D video frame in a 720p50 format, such as the stereoscopic 720p50 format 110c, the side-by-side (half) 720p50 format 120e, the top-and-bottom (half) 720p50 format 130c or the frame packing 720p50 format 140c, may comprise a resolution of 1280×720 pixels in progressive scan mode at a 50 Hz frame rate. In this regard, for example, a left view 121 or a right view 122 in the side-by-side (half) 720p50 format 120e may comprise a resolution of 640×720 pixels. A left view 131 or a right view 132 in the top-and-bottom (half) 720p50 format 130c may comprise a resolution of 1280×360 pixels. A left view 141 or a right view 142 in the frame packing 720p50 format 140c may comprise a resolution of 1280×720 pixels.

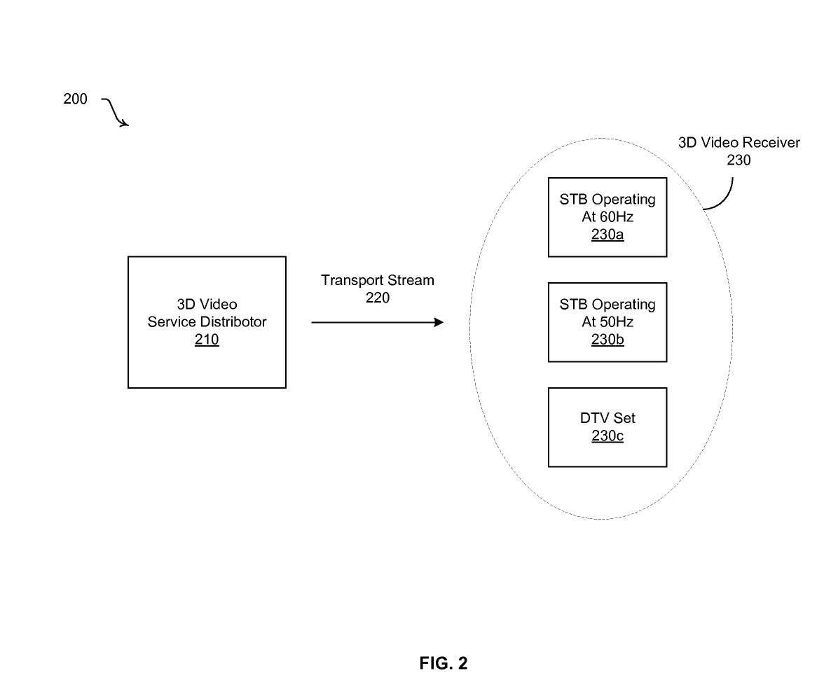

FIG. 2 is a block diagram illustrating an exemplary video communication system that is operable to provide multiple progressive 3D video format conversion, in accordance with an embodiment of the invention. Referring to FIG. 2, there is shown a video communication system 200. The video communication system 200 may comprise a 3D video service distributor 210, a transport stream 220 and a 3D video receiver 230.

The 3D video service distributor 210 may comprise suitable logic, circuitry, interfaces and/or code that may be operable to distribute 3D video content to the 3D video receiver 230 via a bitstream such as the transport stream 220. The 3D service distributor 210 such as, for example, a headend system may be operable to provide various services such as, for example, distribution, multicast, and/or quality of service necessary for a reliable and timely transmission of 3D video content to the 3D video receiver 230. The 3D service distributor 210 may utilize, for example, a cable TV network, a satellite broadcasting network, the Internet protocol (IP) data network such as the Internet, and/or a wireless communication network for delivery of services or 3D video content to the 3D video receiver 230. The 3D video may be encoded or compressed using a MVC method and transmitted to the 3D video receiver 230 via the transport stream 220, for example.

The 3D video receiver 230 may comprise suitable logic, circuitry, interfaces and/or code that may be operable to receive the compressed 3D video via a bitstream such as the transport stream 220 from the 3D video service distributor 210. The 3D video receiver 230 may decode or decompress the received compressed 3D video into a decompressed 3D video. The 3D video receiver 230 may be, for example, a STB operating at 60 Hz 230a, a STB operating at 50 Hz 230b or a DTV set 230c. The STB operating at 60 Hz 230a is a STB, such as a STB using NTSC video standard, which operates at 60 Hz vertical scanning frequency. The STB operating at 50 Hz 230b is a STB, such as a STB using PAL video standard, which operates at 50 Hz vertical scanning frequency. In an exemplary embodiment of the invention, the DTV set 230c may be operable to receive a decompressed 3D video from other 3D video receiver such as the STB operating at 60 Hz 230a and/or the STB operating at 50 Hz 230b, via, for example, a high-definition multimedia interface (HDMI) connection.

In operation, the 3D video receiver 230 may be operable to convert a decompressed 3D video frame from a first 3D video progressive format to a second 3D video progressive format using scaling, where the second 3D video progressive format may comprise a HDMI 3D video format. The decompressed 3D video frame may comprise, for example, a MVC decompressed 3D video frame.

An EPG provides users with continuously updated menus displaying scheduling information for current and upcoming programs. In the EPG mode, the EPG graphics plane may comprise a video showing current program.

A graphics over video may provide graphics to be placed over 3D video frames. The graphics may be 2D graphics or 3D graphics. For example, the graphics associated with a program manual may be placed over 3D video frames associated with current program.

In instances when the 3D video receiver 230 is operating in an EPG mode or in a graphics over video mode, the 3D video receiver 230 may be operable to blend the converted decompressed 3D video frame which may be in the second 3D video progressive format with graphics. In this regard, in instances when the graphics may comprise 3D graphics, a depth of the 3D graphics and/or a depth of the converted decompressed 3D video frame having the second 3D video progressive format may be adjusted coordinately by the 3D video receiver 230 for a blended frame to provide better overall depth of the blended frame. For example, the depth of the converted decompressed 3D video frame having the second 3D video progressive format may be adjusted or pushed back so as to allow the 3D graphics to appear in front of the converted decompressed 3D video frame. The depth of the 3D graphics may be adjusted or pushed back so as to allow the converted decompressed 3D video frame having the second 3D video progressive format to appear in front of the 3D graphics, for example.

The scaling may be used to convert a video frame from a first resolution to a different resolution. For example, by performing a side-by-side 1080p to top-and-bottom 1080p scaling, a left view 121 at a resolution of 960×1080 pixels may be scaled to a left view 131 at a resolution of 1920×540 pixels, and a right view 122 at a resolution of 960×1080 pixels may be scaled to a right view 132 at a resolution of 1920×540 pixels. The side-by-side (half) 1080p24 format 120c may be converted to the top-and-bottom (half) 1080p24 format 130a. By performing a side-by-side 1080p to frame packing 1080p scaling, a left view 121 at a resolution of 960×1080 pixels may be scaled to a left view 141 at a resolution of 1920×1080 pixels, and a right view 122 at a resolution of 960×1080 pixels may be scaled to a right view 142 at a resolution of 1920×1080 pixels. The side-by-side (half) 1080p24 format 120c may be converted to the frame packing 1080p24 format 140a. By performing a side-by-side 1080p to frame packing 720p scaling, a left view 121 at a resolution of 960×1080 pixels may be scaled to a left view 141 at a resolution of 1280×720 pixels, and a right view 122 at a resolution of 960×1080 pixels may be scaled to a right view 142 at a resolution of 1280×720 pixels.

The pulldown is a telecine process which may convert a video frame at a frame rate to an interlaced video frame at different frame rate. The pulldown may comprise 3:2 pulldown or 2:2 pulldown. For example, a 1080p24 format may be converted to a 1080i60 format by performing a 3:2 pulldown. A 1080p24 format may be converted to a 1080i50 format by performing a 2:2 pulldown.

The frame rate up-conversion (FRUC) may be used to convert a video frame from current frame rate to a different frame rate. For example, a video frame in a 720p24 format may be converted to a 720p60 format by performing a 24 Hz to 60 Hz frame rate up-conversion (FRUC). A video frame in a 720p24 format may be converted to a 720p50 format by performing a 24 Hz to 50 Hz frame rate up-conversion (FRUC). A video frame in a 720p50 format may be converted to a 720p60 format by performing a 50 Hz to 60 Hz frame rate up-conversion (FRUC). In an exemplary embodiment of the invention, the 3D video receiver 230 may be operating in an EPG mode or in a graphics over video mode. In this instance, for example, instead of using a frame rate up-conversion (FRUC), a progressive 3D video frame at a 24 Hz frame rate may be converted to a progressive 3D video frame at a 60 Hz frame rate using a 3:2 pulldown. A progressive 3D video frame at a 24 Hz frame rate may be converted to a progressive 3D video frame at a 50 Hz frame rate using a 2:2 pulldown. In this regard, visual artifacts associated with a FRUC may be minimized or reduced.

In an exemplary embodiment of the invention, the 3D video receiver 230 may comprise the STB operating at 60 Hz 230a. In this regard, the first 3D video progressive format, which may be converted to the second 3D video progressive format, may comprise, for example, side-by-side (half) 1080p24 120c, side-by-side (half) 720p60 120d, side-by-side (half) 1080p60 120f, top-and-bottom (half) 1080p24 130a, top-and-bottom (half) 720p60 130b, top-and-bottom (half) 1080p60 130d, stereoscopic 1080p24 110a and/or stereoscopic 720p60 110b. The second 3D video progressive format may be a HDMI 3D video format for transmitting the decompressed 3D video frame to a 3D display device such as the DTV set 230c, via a HDMI connection. In this regard, the second 3D video progressive format may comprise, for example, side-by-side (half) 1080p24 120c, side-by-side (half) 720p60 120d, top-and-bottom (half) 1080p24 130a, top-and-bottom (half) 720p60 130b, frame packing 1080p24 140a and/or frame packing 720p60 140b.

In instances when the second 3D video progressive format may comprise the side-by-side (half) 1080p24 format 120c, the STB operating at 60 Hz 230a may be operable to further convert the decompressed 3D video frame from the second 3D video progressive format, which is the side-by-side (half) 1080p24 format 120c, to side-by-side (half) 1080i60 format 120a by performing a 3:2 pulldown.

In an exemplary embodiment of the invention, the 3D video receiver 230 may comprise the STB operating at 50 Hz 230b. In this regard, the first 3D video progressive format, which may be converted to the second 3D video progressive format, may comprise, for example, side-by-side (half) 1080p24 120c, side-by-side (half) 720p50 120e, side-by-side (half) 1080p50 120g, top-and-bottom (half) 1080p24 130a, top-and-bottom (half) 720p50 130c, top-and-bottom (half) 1080p50 130e, stereoscopic 1080p24 110a and/or stereoscopic 720p50 110c. The second 3D video progressive format may be a HDMI 3D video format for transmitting the decompressed 3D video frame to a 3D display device such as the DTV set 230c, via a HDMI connection. In this regard, the second 3D video progressive format may comprise, for example, side-by-side (half) 1080p24 120c, side-by-side (half) 720p50 120e, top-and-bottom (half) 1080p24 130a, top-and-bottom (half) 720p50 130c, frame packing 1080p24 140a and/or frame packing 720p50 140c.

In instances when the second 3D video progressive format may comprise the side-by-side (half) 1080p24 format 120c, the STB operating at 50 Hz 230b may be operable to further convert the decompressed 3D video frame from the second 3D video progressive format, which is the side-by-side (half) 1080p24 format 120c, to side-by-side (half) 1080i50 format 120b by performing a 2:2 pulldown.

In another exemplary embodiment of the invention, the 3D video receiver 230 may comprise the DTV set 230c. In this regard, the first 3D video progressive format, which may be converted to the second 3D video progressive format, may comprise, for example, side-by-side (half) 1080p24 120c, side-by-side (half) 720p60120d, side-by-side (half) 720p50 120e, side-by-side (half) 1080p60 120f, side-by-side (half) 1080p50 120g, top-and-bottom (half) 1080p24 130a, top-and-bottom (half) 720p60 130b, top-and-bottom (half) 720p50 130c, top-and-bottom (half) 1080p60 130d and/or top-and-bottom (half) 1080p50 130e. The second 3D video progressive format may comprise, for example, frame packing 1080p24 140a, frame packing 720p60 140b and/or frame packing 720p50 140c.

In an exemplary embodiment of the invention, the DTV set 230c may be operable to convert, for example, the decompressed 3D video frame from the first 3D video progressive format at a 50 Hz field rate to the second 3D video progressive format at a 50 Hz frame rate using the scaling. The second 3D video progressive format at the 50 Hz frame rate may then be converted by the DTV set 230c to a third 3D video progressive format at a 60 Hz frame rate using frame rate up-conversion (FRUC). In this regard, for example, the first 3D video progressive format at 50 Hz field rate may comprise side-by-side (half) 720p50 120e and/or top-and-bottom (half) 720p50 130c. The second 3D video progressive format at the 50 Hz frame rate may comprise frame packing 720p50 140c. The third 3D video progressive format at the 60 Hz frame rate may comprise frame packing 720p60 140b.

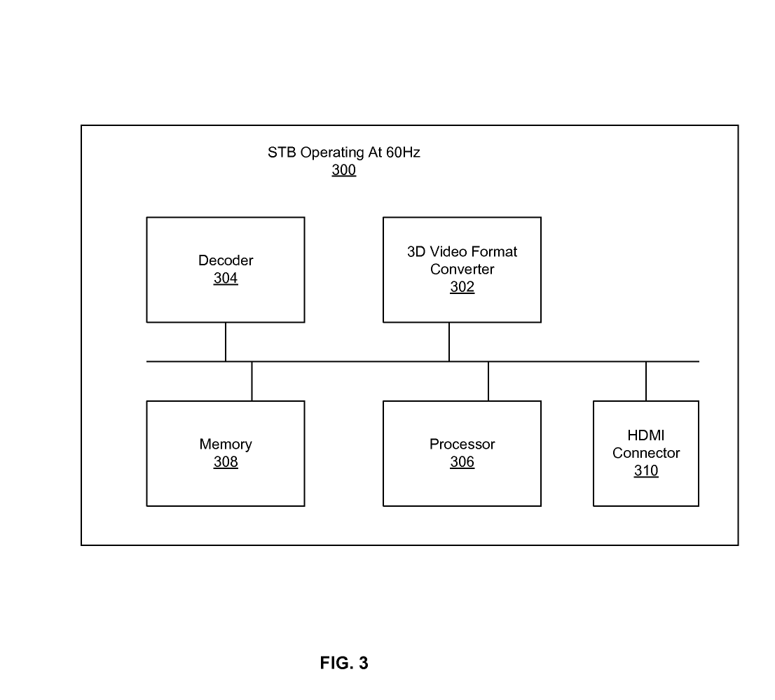

FIG. 3 is a block diagram illustrating an exemplary STB that operates at 60 Hz to provide multiple progressive 3D video format conversion, in accordance with an embodiment of the invention. Referring to FIG. 3, there is shown a STB operating at 60 Hz 300. The STB operating at 60 Hz 300 may comprise a 3D video format converter 302, a decoder 304, a processor 306, a memory 308 and a HDMI connector 310.

The 3D video format converter 302 may comprise suitable logic, circuitry, interfaces and/or code that may be operable to receive decompressed 3D video frames from the decoder 304. The 3D video format converter 302 may be operable to convert a decompressed 3D video frame from a first 3D video format to a second 3D video format using scaling and/or 3:2 pulldown. In this regard, the first 3D video format, which may be converted to the second 3D video format, may comprise, for example, side-by-side (half) 1080p60 120f, side-by-side (half) 1080p24 120c, side-by-side (half) 720p60 120d, top-and-bottom (half) 1080p60 130d, top-and-bottom (half) 1080p24 130a, top-and-bottom (half) 720p60 130b, stereoscopic 1080p24 110a and/or stereoscopic 720p60 110b. The second 3D video format may be, for example, a HDMI 3D video format for transmitting the decompressed 3D video frame to a 3D display device such as the DTV set 230c, via the HDMI connector 310. In this regard, the second video format may comprise, for example, side-by-side (half) 1080i60 120a, side-by-side (half) 1080p24 120c, side-by-side (half) 720p60 120d, top-and-bottom (half) 1080p24 130a, top-and-bottom (half) 720p60 130b, frame packing 1080p24 140a and/or frame packing 720p60 140b.

In instances when the STB operating at 60 Hz 300 is in an EPG mode or in a graphics over video mode, the 3D video format converter 302 may be operable to blend the converted decompressed 3D video frame which may be in the second 3D video format with graphics.

The decoder 304 may comprise suitable logic, circuitry, interfaces and/or code that may be operable to decode or decompress compressed 3D video frames which may be received from the 3D video service distributor 210 via the transport stream 220. The decoder 304 may be operable to decompress the compressed 3D video frames using, for example, a MVC decoding.

The processor 306 may comprise suitable logic, circuitry, interfaces and/or code that may be operable to communicate with the decoder 304 and the 3D video format converter 302 to perform the decoding functions and the 3D video format conversion functions of the STB operating at 60 Hz 300.

The memory 308 may comprise suitable logic, circuitry, interfaces and/or code that may be operable to store information such as executable instructions and data that may be utilized by the processor 306, the decoder 304 and/or the 3D video format converter 302 to perform various functions of the STB operating at 60 Hz 300.

The HDMI connector 310 may comprise suitable logic, circuitry, interfaces and/or code that may be operable to provide HDMI connection to a 3D display device such as the DTV set 230c.

In operation, the decoder 304 may be operable to decode or decompress compressed 3D video frames, which may be received from the 3D video service distributor 210 via the transport stream 220. The decoder 304 may be operable to decompress the compressed 3D video frames using, for example, a MVC decoding. The 3D video format converter 302 may be operable to receive decompressed 3D video frames from the decoder 304. The 3D video format converter 302 may be operable to convert a decompressed 3D video frame from a first 3D video format to a second 3D video format using the scaling and/or the 3:2 pulldown. In this regard, the first 3D video format, which may be converted to the second 3D video format, may comprise, for example, side-by-side (half) 1080p60 120f, side-by-side (half) 1080p24 120c, side-by-side (half) 720p60 120d, top-and-bottom (half) 1080p60 130d, top-and-bottom (half) 1080p24 130a, top-and-bottom (half) 720p60 130b, stereoscopic 1080p24 110a and/or stereoscopic 720p60 110b. The second 3D video format may be, for example, a HDMI 3D video format for transmitting the decompressed 3D video frame to a 3D display device such as the DTV set 230c, via the HDMI connector 310. In this regard, the second video format may comprise, for example, side-by-side (half) 1080i60 120a, side-by-side (half) 1080p24 120c, side-by-side (half) 720p60 120d, top-and-bottom (half) 1080p24 130a, top-and-bottom (half) 720p60 130b, frame packing 1080p24 140a and/or frame packing 720p60 140b.

In instances when the STB operating at 60 Hz 300 is in an EPG mode or in a graphics over video mode, the 3D video format converter 302 may be operable to blend the converted decompressed 3D video frame which may be in the second 3D video format with graphics. In this regard, in instances when the graphics may comprise 3D graphics, a depth of the 3D graphics and/or a depth of the converted decompressed 3D video frame may be adjusted coordinately by the 3D video format converter 302 for a blended frame to provide better overall depth of the blended frame.

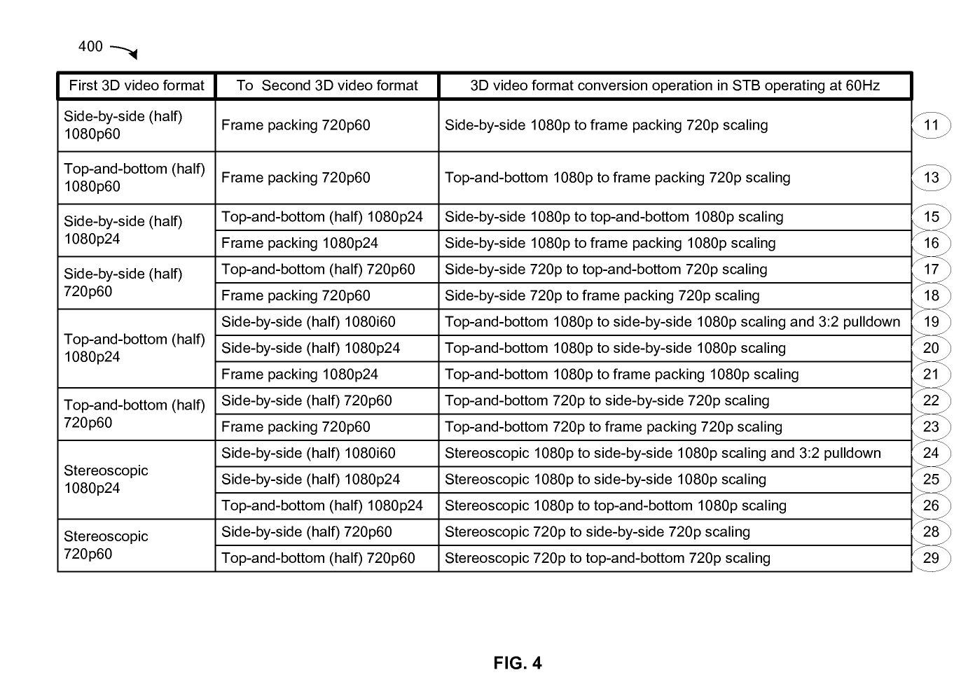

FIG. 4 is an exemplary table that illustrates progressive 3D video format conversion performed by a STB operating at 60 Hz, in accordance with an embodiment of the invention. Referring to FIG. 4, there is shown a table 400.

A side-by-side (half) 1080p60 format 120f may be converted to a frame packing 720p60 format 140b by performing side-by-side 1080p to frame packing 720p scaling as illustrated by the reference label 11.

A top-and-bottom (half) 1080p60 format 130d may be converted to a frame packing 720p60 format 140b by performing top-and-bottom 1080p to frame packing 720p scaling as illustrated by the reference label 13.

A side-by-side (half) 1080p24 format 120c may be converted to a top-and-bottom (half) 1080p24 format 130a by performing side-by-side 1080p to top-and-bottom 1080p scaling as illustrated by the reference label 15.

A side-by-side (half) 1080p24 format 120c may be converted to a frame packing 1080p24 format 140a by performing side-by-side 1080p to frame packing 1080p scaling as illustrated by the reference label 16.

A side-by-side (half) 720p60 format 120d may be converted to a top-and-bottom (half) 720p60 format 130b by performing side-by-side 720p to top-and-bottom 720p scaling as illustrated by the reference label 17.

A side-by-side (half) 720p60 format 120d may be converted to a frame packing 720p60 format 140b by performing side-by-side 720p to frame packing 720p scaling as illustrated by the reference label 18.

A top-and-bottom (half) 1080p24 format 130a may be converted to a side-by-side (half) 1080i60 format 120a by performing top-and-bottom 1080p to side-by-side 1080p scaling and 3:2 pulldown as illustrated by the reference label 19.

A top-and-bottom (half) 1080p24 format 130a may be converted to a side-by-side (half) 1080p24 format 120c by performing top-and-bottom 1080p to side-by-side 1080p scaling as illustrated by the reference label 20.

A top-and-bottom (half) 1080p24 format 130a may be converted to a frame packing 1080p24 format 140a by performing top-and-bottom 1080p to frame packing 1080p scaling as illustrated by the reference label 21.

A top-and-bottom (half) 720p60 format 130b may be converted to a side-by-side (half) 720p60 format 120d by performing top-and-bottom 720p to side-by-side 720p scaling as illustrated by the reference label 22.

A top-and-bottom (half) 720p60 format 130b may be converted to a frame packing 720p60 format 140b by performing top-and-bottom 720p to frame packing 720p scaling as illustrated by the reference label 23.

A stereoscopic 1080p24 format 110a may be converted to a side-by-side (half) 1080i60 format 120a by performing stereoscopic 1080p to side-by-side 1080p scaling and 3:2 pulldown as illustrated by the reference label 24.

A stereoscopic 1080p24 format 110a may be converted to a side-by-side (half) 1080p24 format 120c by performing stereoscopic 1080p to side-by-side 1080p scaling as illustrated by the reference label 25.

A stereoscopic 1080p24 format 110a may be converted to a top-and-bottom (half) 1080p24 format 130a by performing stereoscopic 1080p to top-and-bottom 1080p scaling as illustrated by the reference label 26.

A stereoscopic 720p60 format 110b may be converted to a side-by-side (half) 720p60 format 120d by performing stereoscopic 720p to side-by-side 720p scaling as illustrated by the reference label 28.

A stereoscopic 720p60 format 110b may be converted to a top-and-bottom (half) 720p60 format 130b by performing stereoscopic 720p to top-and-bottom 720p scaling as illustrated by the reference label 29.

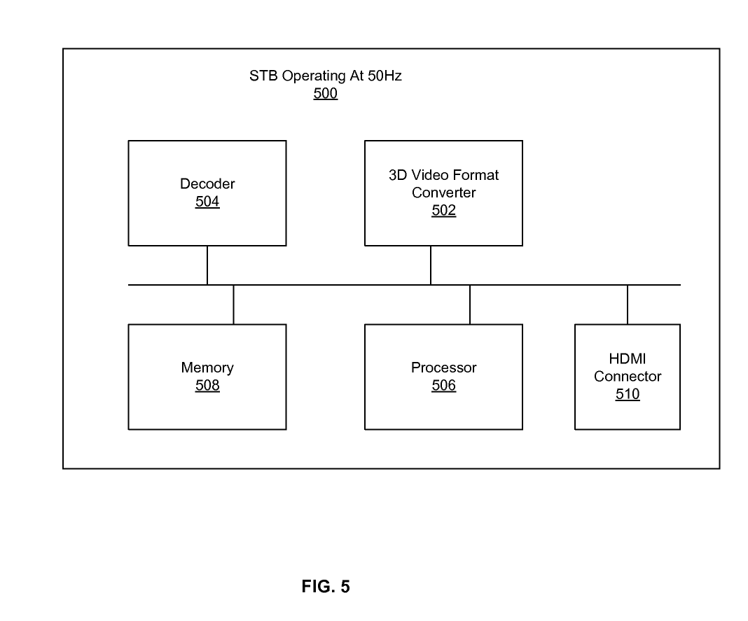

FIG. 5 is a block diagram illustrating an exemplary STB that operates at 50 Hz to provide multiple progressive 3D video format conversion, in accordance with an embodiment of the invention. Referring to FIG. 5, there is shown a STB operating at 50 Hz 500. The STB operating at 50 Hz 500 may comprise a 3D video format converter 502, a decoder 504, a processor 506, a memory 508 and a HDMI connector 510.

The 3D video format converter 502 may comprise suitable logic, circuitry, interfaces and/or code that may be operable to receive decompressed 3D video frames from the decoder 504. The 3D video format converter 502 may be operable to convert a decompressed 3D video frame from a first 3D video format to a second 3D video format using scaling and/or 2:2 pulldown. In this regard, the first 3D video format, which may be converted to the second 3D video format, may comprise, for example, side-by-side (half) 1080p50 120g, side-by-side (half) 1080p24 120c, side-by-side (half) 720p50 120e, top-and-bottom (half) 1080p50 130e, top-and-bottom (half) 1080p24 130a, top-and-bottom (half) 720p50 130c, stereoscopic 1080p24 110a and/or stereoscopic 720p50 110c. The second 3D video format may be, for example, a HDMI 3D video format for transmitting the decompressed 3D video frame to a 3D display device such as the DTV set 230c, via the HDMI connector 510. In this regard, the second 3D video format may comprise, for example, side-by-side (half) 1080i50 120b, side-by-side (half) 1080p24 120c, side-by-side (half) 720p50 120e, top-and-bottom (half) 1080p24 130a, top-and-bottom (half) 720p50 130c, frame packing 1080p24 140a and/or frame packing 720p50 140c.

In instances when the STB operating at 50 Hz 500 is in an EPG mode or in a graphics over video mode, the 3D video format converter 502 may be operable to blend the converted decompressed 3D video frame which may be in the second 3D video format with graphics.

The decoder 504 may comprise suitable logic, circuitry, interfaces and/or code that may be operable to decode or decompress compressed 3D video frames which may be received from the 3D video service distributor 210 via the transport stream 220. The decoder 504 may be operable to decompress the compressed 3D video frames using, for example, a MVC decoding.

The processor 506 may comprise suitable logic, circuitry, interfaces and/or code that may be operable to communicate with the decoder 504 and the 3D video format converter 502 to perform the decoding functions and the 3D video format conversion functions of the STB operating at 50 Hz 500.

The memory 508 may comprise suitable logic, circuitry, interfaces and/or code that may be operable to store information such as executable instructions and data that may be utilized by the processor 506, the decoder 504 and/or the 3D video format converter 502 to perform various functions of the STB operating at 50 Hz 500.

The HDMI connector 510 may comprise suitable logic, circuitry, interfaces and/or code that may be operable to provide HDMI connection to a 3D display device such as the DTV set 230c.

In operation, the decoder 504 may be operable to decode or decompress compressed 3D video frames which may be received from the 3D video service distributor 210 via the transport stream 220. The decoder 504 may be operable to decompress the compressed 3D video frames using, for example, a MVC decoding. The 3D video format converter 502 may be operable to receive decompressed 3D video frames from the decoder 504. The 3D video format converter 502 may be operable to convert a decompressed 3D video frame from a first 3D video format to a second 3D video format using the scaling and/or the 2:2 pulldown. In this regard, the first 3D video format, which may be converted to the second 3D video format, may comprise, for example, side-by-side (half) 1080p50 120g, side-by-side (half) 1080p24 120c, side-by-side (half) 720p50 120e, top-and-bottom (half) 1080p50 130e, top-and-bottom (half) 1080p24 130a, top-and-bottom (half) 720p50 130c, stereoscopic 1080p24 110a and/or stereoscopic 720p50 110c. The second 3D video format may be, for example, a HDMI 3D video format for transmitting the decompressed 3D video frame to a 3D display device such as the DTV set 230c, via the HDMI connector 510. In this regard, the second 3D video format may comprise, for example, side-by-side (half) 1080i50 120b, side-by-side (half) 1080p24 120c, side-by-side (half) 720p50 120e, top-and-bottom (half) 1080p24 130a, top-and-bottom (half) 720p50 130c, frame packing 1080p24 140a and/or frame packing 720p50 140c.

In instances when the STB operating at 50 Hz 500 is in an EPG mode or in a graphics over video, the 3D video format converter 502 may be operable to blend the converted decompressed 3D video frame which may be in the second 3D video format with graphics. In this regard, in instances when the graphics may comprise 3D graphics, a depth of the 3D graphics and/or a depth of the converted decompressed 3D video frame may be adjusted coordinately by the 3D video format converter 502 for a blended frame to provide better overall depth of the blended frame.

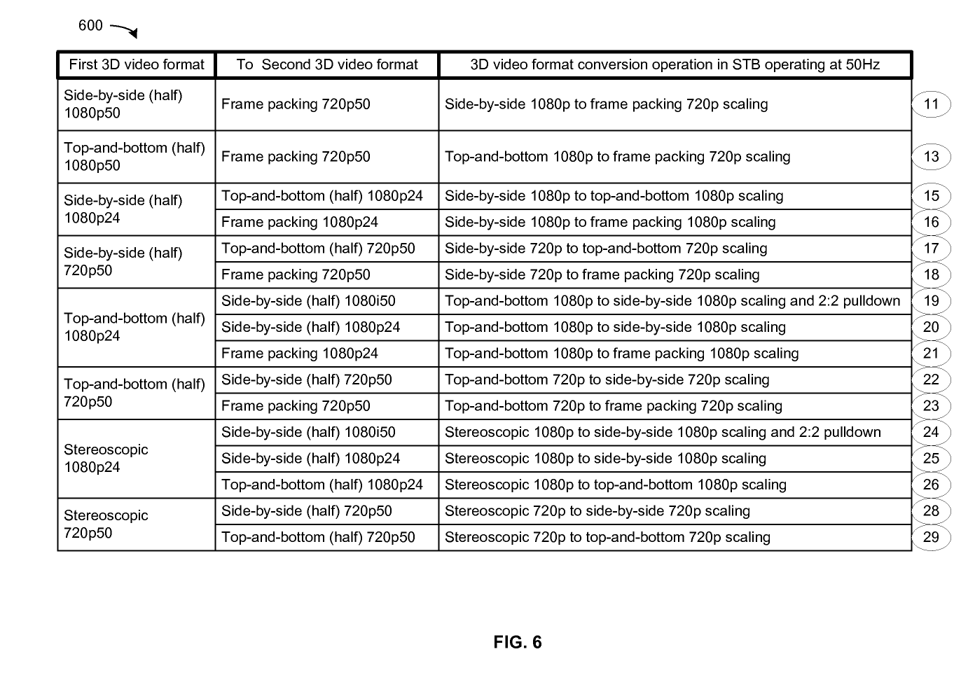

FIG. 6 is an exemplary table that illustrates progressive 3D video format conversion performed by a STB operating at 50 Hz, in accordance with an embodiment of the invention. Referring to FIG. 6, there is shown a table 600.

A side-by-side (half) 1080p50 format 120g may be converted to a frame packing 720p50 format 140c by performing side-by-side 1080p to frame packing 720p scaling as illustrated by the reference label 11.

A top-and-bottom (half) 1080p50 format 130e may be converted to a frame packing 720p50 format 140c by performing top-and-bottom 1080p to frame packing 720p scaling as illustrated by the reference label 13.

A side-by-side (half) 1080p24 format 120c may be converted to a top-and-bottom (half) 1080p24 format 130a by performing side-by-side 1080p to top-and-bottom 1080p scaling as illustrated by the reference label 15.

A side-by-side (half) 1080p24 format 120c may be converted to a frame packing 1080p24 format 140a by performing side-by-side 1080p to frame packing 1080p scaling as illustrated by the reference label 16.

A side-by-side (half) 720p50 format 120e may be converted to a top-and-bottom (half) 720p50 format 130c by performing side-by-side 720p to top-and-bottom 720p scaling as illustrated by the reference label 17.

A side-by-side (half) 720p50 format 120e may be converted to a frame packing 720p50 format 140c by performing side-by-side 720p to frame packing 720p scaling as illustrated by the reference label 18.

A top-and-bottom (half) 1080p24 format 130a may be converted to a side-by-side (half) 1080i50 format 120b by performing top-and-bottom 1080p to side-by-side 1080p scaling and 2:2 pulldown as illustrated by the reference label 19.

A top-and-bottom (half) 1080p24 format 130a may be converted to a side-by-side (half) 1080p24 format 120c by performing top-and-bottom 1080p to side-by-side 1080p scaling as illustrated by the reference label 20.

A top-and-bottom (half) 1080p24 format 130a may be converted to a frame packing 1080p24 format 140a by performing top-and-bottom 1080p to frame packing 1080p scaling as illustrated by the reference label 21.

A top-and-bottom (half) 720p50 format 130c may be converted to a side-by-side (half) 720p50 format 120e by performing top-and-bottom 720p to side-by-side 720p scaling as illustrated by the reference label 22.

A top-and-bottom (half) 720p50 format 130c may be converted to a frame packing 720p50 format 140c by performing top-and-bottom 720p to frame packing 720p scaling as illustrated by the reference label 23.

A stereoscopic 1080p24 format 110a may be converted to a side-by-side (half) 1080i50 format 120b by performing stereoscopic 1080p to side-by-side 1080p scaling and 2:2 pulldown as illustrated by the reference label 24.

A stereoscopic 1080p24 format 110a may be converted to a side-by-side (half) 1080p24 format 120c by performing stereoscopic 1080p to side-by-side 1080p scaling as illustrated by the reference label 25.

A stereoscopic 1080p24 format 110a may be converted to a top-and-bottom (half) 1080p24 format 130a by performing stereoscopic 1080p to top-and-bottom 1080p scaling as illustrated by the reference label 26.

A stereoscopic 720p50 format 110c may be converted to a side-by-side (half) 720p50 format 120e by performing stereoscopic 720p to side-by-side 720p scaling as illustrated by the reference label 28.

A stereoscopic 720p50 format 110c may be converted to a top-and-bottom (half) 720p50 format 130c by performing stereoscopic 720p to top-and-bottom 720p scaling as illustrated by the reference label 29.

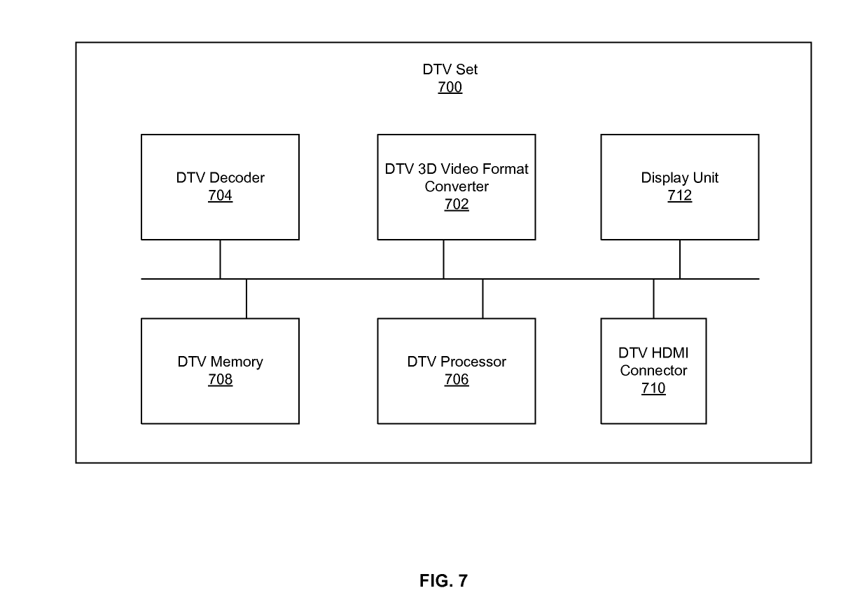

FIG. 7 is a block diagram illustrating an exemplary DTV set that is operable to provide multiple progressive 3D video format conversion, in accordance with an embodiment of the invention. Referring to FIG. 7, there is shown a DTV set 700. The DTV set 700 may comprise a DTV 3D video format converter 702, a DTV decoder 704, a DTV processor 706, a DTV memory 708, a DTV HDMI connector 710 and a display unit 712.

The DTV 3D video format converter 702 may comprise suitable logic, circuitry, interfaces and/or code that may be operable to receive decompressed 3D video frames from the DTV decoder 704. In an exemplary embodiment of the invention, the DTV 3D video format converter 702 may be operable to also receive decompressed video frames from other 3D video receiver such as the STB operating at 60 Hz 230a and/or the STB operating at 50 Hz 230b via, for example, the DTV HDMI connector 710. The DTV 3D video format converter 702 may be operable to convert a decompressed 3D video frame from a first 3D video format to a second 3D video format using scaling, frame rate up-conversion (FRUC) and/or pulldown. In this regard, the first 3D video format, which may be converted to the second 3D video format, may comprise, for example, side-by-side (half) 1080p60 120f, side-by-side (half) 1080p50 120g, side-by-side (half) 1080p24 120c, side-by-side (half) 720p60 120d, side-by-side (half) 720p50 120e, top-and-bottom (half) 1080p60 130d, top-and-bottom (half) 1080p50 130e, top-and-bottom (half) 1080p24 130a, top-and-bottom (half) 720p60 130b, top-and-bottom (half) 720p50 130c and/or stereoscopic 1080p24 110a. The second 3D video format may comprise, for example, frame packing 1080p24 140a, frame packing 720p60 140b and/or frame packing 720p50 140c.

The DTV decoder 704 may comprise suitable logic, circuitry, interfaces and/or code that may be operable to decode or decompress compressed 3D video frames which may be received from the 3D video service distributor 210 via the transport stream 220.

The DTV processor 706 may comprise suitable logic, circuitry, interfaces and/or code that may be operable to communicate with the DTV decoder 704, the DTV 3D video format converter 702 and the display unit 712 to perform the decoding functions, the 3D video format conversion functions and the display functions of the DTV set 700.

The DTV memory 708 may comprise suitable logic, circuitry, interfaces and/or code that may be operable to store information such as executable instructions and data that may be utilized by the DTV processor 706, the DTV decoder 704, the DTV 3D video format converter 702 and/or the display unit 712 to perform various functions of the DTV set 700.

The DTV HDMI connector 710 may comprise suitable logic, circuitry, interfaces and/or code that may be operable to provide HDMI connection to other 3D video receivers such as the STB operating at 60 Hz 230a and/or the STB operating at 50 Hz 230b.

The display unit 712 may comprise suitable logic, circuitry, interfaces and/or code that may be operable to display or present 3D video content to users.

In operation, the DTV decoder 704 may be operable to decode or decompress compressed 3D video frames which may be received from the 3D video service distributor 210 via the transport stream 220. The DTV 3D video format converter 702 may be operable to receive decompressed 3D video frames from the DTV decoder 704. In an exemplary embodiment of the invention, the 3D video format converter 702 may be operable to also receive decompressed video frames from other 3D video receiver such as the STB operating at 60 Hz 230a and/or the STB operating at 50 Hz 230b via, for example, the DTV HDMI connector 710. The DTV 3D video format converter 702 may be operable to convert a decompressed 3D video frame from a first 3D video format to a second 3D video format using the scaling, the frame rate up-conversion (FRUC) and/or the pulldown. In this regard, the first 3D video format, which may be converted to the second 3D video format, may comprise, for example, side-by-side (half) 1080p60 120f, side-by-side (half) 1080p50 120g, side-by-side (half) 1080p24 120c, side-by-side (half) 720p60 120d, side-by-side (half) 720p50 120e, top-and-bottom (half) 1080p60 130d, top-and-bottom (half) 1080p50 130e, top-and-bottom (half) 1080p24 130a, top-and-bottom (half) 720p60 130b, top-and-bottom (half) 720p50 130c, stereoscopic 1080p24 110a. The second 3D video format may comprise, for example, frame packing 1080p24 140a, frame packing 720p60 140b and/or frame packing 720p50 140c.

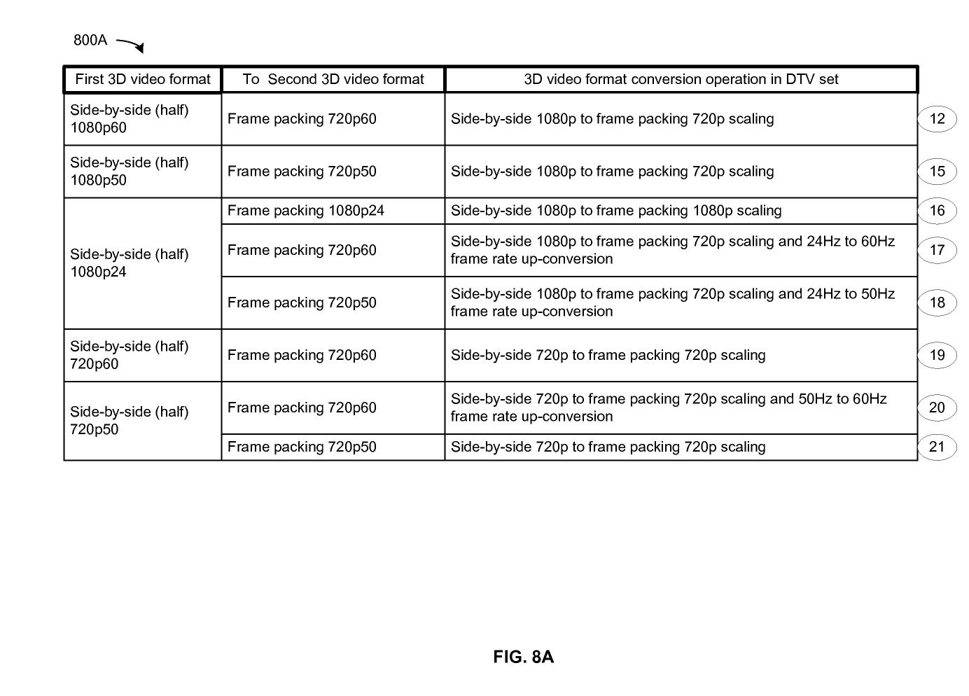

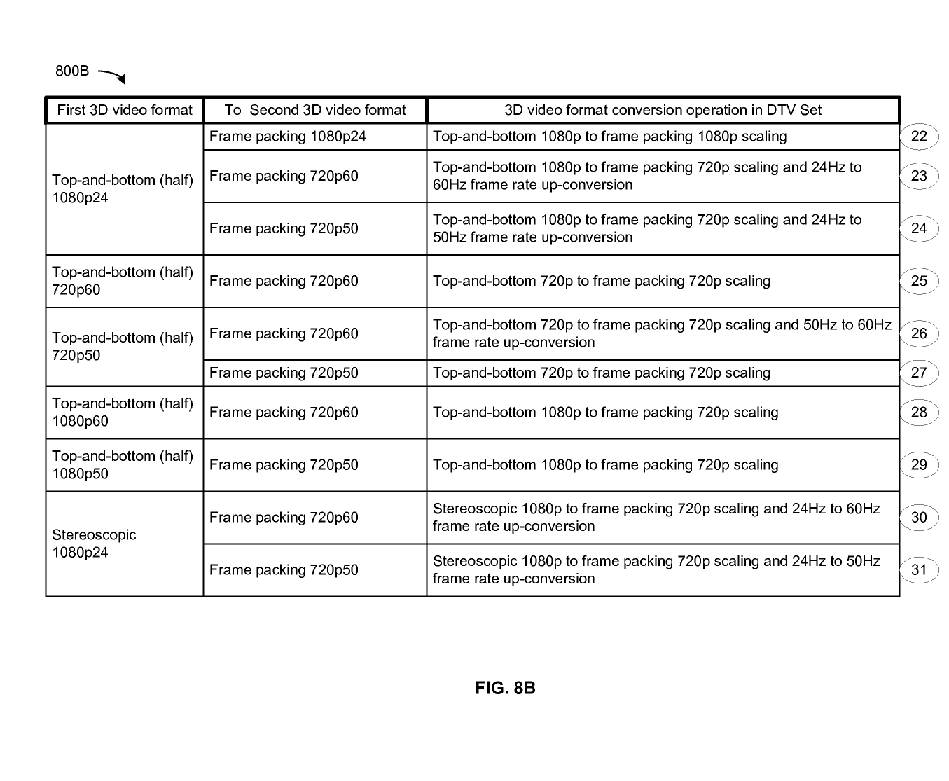

FIG. 8A is an exemplary table that illustrates progressive 3D video format conversion performed by a DTV set, in accordance with an embodiment of the invention. Referring to FIG. 8A, there is shown a table 800A.

A side-by-side (half) 1080p60 format 120f may be converted to a frame packing 720p60 format 140b by performing side-by-side 1080p to frame packing 720p scaling as illustrated by the reference label 12.

A side-by-side (half) 1080p50 format 120g may be converted to a frame packing 720p50 format 140c by performing side-by-side 1080p to frame packing 720p scaling as illustrated by the reference label 15.

A side-by-side (half) 1080p24 format 120c may be converted to a frame packing 1080p24 format 140a by performing side-by-side 1080p to frame packing 1080p scaling as illustrated by the reference label 16.

A side-by-side (half) 1080p24 format 120c may be converted to a frame packing 720p60 format 140b by performing side-by-side 1080p to frame packing 720p scaling and 24 Hz to 60 Hz frame rate up-conversion (FRUC) as illustrated by the reference label 17. In an exemplary embodiment of the invention, when the DTV set 700 may be operating in an EPG mode or in a graphics over video mode, a 3:2 pulldown may be used instead of the 24 Hz to 60 Hz FRUC so as to minimize or reduce visual artifacts.

A side-by-side (half) 1080p24 format 120c may be converted to a frame packing 720p50 format 140c by performing side-by-side 1080p to frame packing 720p scaling and 24 Hz to 50 Hz frame rate up-conversion (FRUC) as illustrated by the reference label 18. In an exemplary embodiment of the invention, when the DTV set 700 may be operating in an EPG mode or in a graphics over video mode, a 2:2 pulldown may be used instead of the 24 Hz to 50 Hz FRUC so as to minimize or reduce visual artifacts.

A side-by-side (half) 720p60 format 120d may be converted to a frame packing 720p60 format 140b by performing side-by-side 720p to frame packing 720p scaling as illustrated by the reference label 19.

A side-by-side (half) 720p50 format 120e may be converted to a frame packing 720p60 format 140b by performing side-by-side 720p to frame packing 720p scaling and 50 Hz to 60 Hz frame rate up-conversion (FRUC) as illustrated by the reference label 20.

A side-by-side (half) 720p50 format 120e may be converted to a frame packing 720p50 format 140c by performing side-by-side 720p to frame packing 720p scaling as illustrated by the reference label 21.

FIG. 8B is an exemplary table that illustrates progressive 3D video format conversion performed by a DTV set, in accordance with an embodiment of the invention. Referring to FIG. 8B, there is shown a table 800B.

A top-and-bottom (half) 1080p24 format 130a may be converted to a frame packing 1080p24 format 140a by performing top-and-bottom 1080p to frame packing 1080p scaling as illustrated by the reference label 22.

A top-and-bottom (half) 1080p24 format 130a may be converted to a frame packing 720p60 format 140b by performing top-and-bottom 1080p to frame packing 720p scaling and 24 Hz to 60 Hz frame rate up-conversion (FRUC) as illustrated by the reference label 23. In an exemplary embodiment of the invention, when the DTV set 700 may be operating in an EPG mode or in a graphics over video mode, a 3:2 pulldown may be used instead of the 24 Hz to 60 Hz FRUC so as to minimize or reduce visual artifacts.

A top-and-bottom (half) 1080p24 format 130a may be converted to a frame packing 720p50 format 140c by performing top-and-bottom 1080p to frame packing 720p scaling and 24 Hz to 50 Hz frame rate up-conversion (FRUC) as illustrated by the reference label 24. In an exemplary embodiment of the invention, when the DTV set 700 may be operating in an EPG mode or in a graphics over video mode, a 2:2 pulldown may be used instead of the 24 Hz to 50 Hz FRUC so as to minimize or reduce visual artifacts.

A top-and-bottom (half) 720p60 format 130b may be converted to a frame packing 720p60 format 140b by performing top-and-bottom 720p to frame packing 720p scaling as illustrated by the reference label 25.

A top-and-bottom (half) 720p50 format 130c may be converted to a frame packing 720p60 format 140b by performing top-and-bottom 720p to frame packing 720p scaling and 50 Hz to 60 Hz frame rate up-conversion (FRUC) as illustrated by the reference label 26.

A top-and-bottom (half) 720p50 format 130c may be converted to a frame packing 720p50 format 140c by performing top-and-bottom 720p to frame packing 720p scaling as illustrated by the reference label 27.

A top-and-bottom (half) 1080p60 format 130d may be converted to a frame packing 720p60 format 140b by performing top-and-bottom 1080p to frame packing 720p scaling as illustrated by the reference label 28.

A top-and-bottom (half) 1080p50 format 130e may be converted to a frame packing 720p50 format 140c by performing top-and-bottom 1080p to frame packing 720p scaling as illustrated by the reference label 29.

A stereoscopic 1080p24 format 110a may be converted to a frame packing 720p60 format 140b by performing stereoscopic 1080p to frame packing 720p scaling and 24 Hz to 60 Hz frame rate up-conversion (FRUC) as illustrated by the reference label 30. In an exemplary embodiment of the invention, when the DTV set 700 may be operating in an EPG mode or in a graphics over video mode, a 3:2 pulldown may be used instead of the 24 Hz to 60 Hz FRUC so as to minimize or reduce visual artifacts.

A stereoscopic 1080p24 format 110a may be converted to a frame packing 720p50 format 140c by performing stereoscopic 1080p to frame packing 720p scaling and 24 Hz to 50 Hz frame rate up-conversion (FRUC) as illustrated by the reference label 31. In an exemplary embodiment of the invention, when the DTV set 700 may be operating in an EPG mode or in a graphics over video mode, a 2:2 pulldown may be used instead of the 24 Hz to 50 Hz FRUC so as to minimize or reduce visual artifacts.

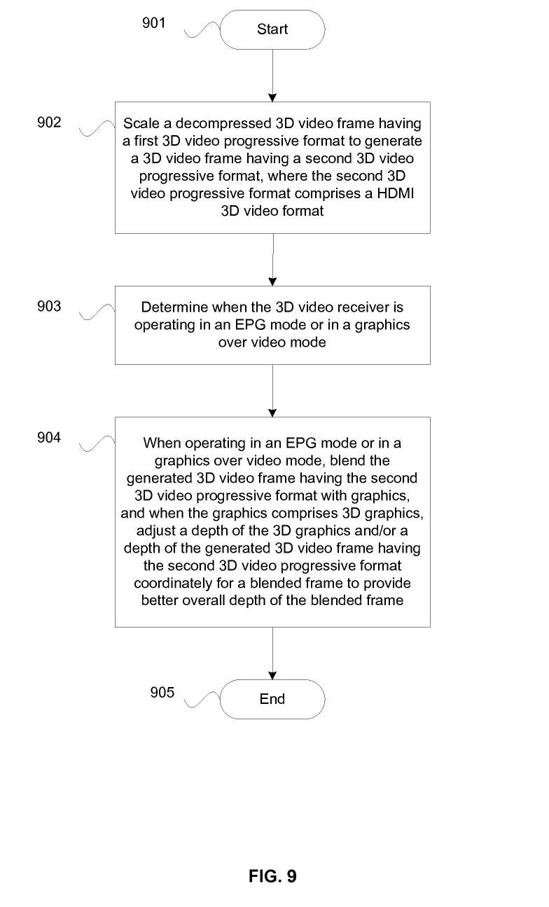

FIG. 9 is a flow chart illustrating exemplary steps for multiple progressive 3D video format conversion, in accordance with an embodiment of the invention. Referring to FIG. 9, the exemplary steps start at step 901. In step 902, a 3D video receiver 230 may be operable to scale a decompressed 3D video frame having a first 3D video progressive format to generate a 3D video frame having a second 3D video progressive format, where the second 3D video progressive format may comprise a HDMI 3D video format. In step 903, the 3D video receiver 230 may be operable to determine when the 3D video receiver 230 may be operating in an EPG mode or in a graphics over video mode. In step 904, when operating in an EPG mode or in a graphics over video mode, the 3D video receiver 230 may be operable to blend the generated 3D video frame having the second 3D video progressive format with graphics. In instances when the graphics may comprise 3D graphics, a depth of the 3D graphics and/or a depth of the generated 3D video frame having the second 3D video progressive format may be adjusted coordinately by the 3D video receiver 230 for a blended frame to provide better overall depth of the blended frame. The exemplary steps may proceed to the end step 905.

In various embodiments of the invention, a 3D video receiver 230 may be operable to scale a decompressed 3D video frame having a first 3D video progressive format to generate a 3D video frame having a second 3D video progressive format, where the second 3D video progressive format may comprise a HDMI 3D video format. The second 3D video progressive format may comprise, for example, side-by-side (half) 1080p24 format 120c, side-by-side (half) 720p60 format 120d, side-by-side (half) 720p50 format 120e, top-and-bottom (half) 1080p24 format 130a, top-and-bottom (half) 720p60 format 130b, top-and-bottom (half) 720p50 format 130c, frame packing 1080p24 format 140a, frame packing 720p60 format 140b and/or frame packing 720p50 format 140c.

The 3D video receiver 230 may be operable to determine when the 3D video receiver 230 may be operating in an EPG mode or in a graphics over video mode. In instances when the 3D video receiver 230 is operating in the EPG mode or in the graphics over video mode, the generated 3D video frame having the second 3D video progressive format may be blended with graphics by the 3D video receiver 230. In this regard, in instances when the graphics may comprise 3D graphics, a depth of the 3D graphics and/or a depth of the generated 3D video frame having the second 3D video progressive format may be adjusted coordinately by the 3D video receiver 230 for a blended frame to provide better overall depth of the blended frame.

In an exemplary embodiment of the invention, the 3D video receiver 230 may be operable to scale the decompressed 3D video frame having the first 3D video progressive format, which may comprise a 24 Hz frame rate, to generate the 3D video frame having the second 3D video progressive format, which may comprise a 24 Hz frame rate. The generated 3D video frame having the second 3D video progressive format may be further converted by the 3D video receiver 230 to generate a 3D video frame having a 3D video interlaced format by performing a pulldown. In this regard, for example, the generated 3D video frame having the second 3D video progressive format, which may comprise a 24 Hz frame rate, may be converted by the 3D video receiver 230 to generate a 3D video frame having a 3D video interlaced format, which may comprise a 60 Hz field rate, by performing a 3:2 pulldown. The generated 3D video frame having the second 3D video progressive format, which may comprise a 24 Hz frame rate, may be converted by the 3D video receiver 230 to generate a 3D video frame having a 3D video interlaced format, which may comprise a 50 Hz field rate, by performing a 2:2 pulldown.

In an exemplary embodiment of the invention, the 3D video receiver 230 may be operable to scale the decompressed 3D video frame having the first 3D video progressive format, which may comprise a 50 Hz frame rate, to generate the 3D video frame having the second 3D video progressive format, which may comprise a 50 Hz frame rate. The generated 3D video frame having the second 3D video progressive format, which may comprise a 50 Hz frame rate, may be frame-rate upconverted by the 3D video receiver 230 to generate a 3D video frame having a third 3D video progressive format, which may comprise a 60 Hz frame rate.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for multiple progressive 3D video format conversion.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing video, the method comprising:
in a 3-dimensional (3D) video receiver:
scaling a decompressed 3D video frame having a first 3D video progressive format to generate a 3D video frame having a second 3D video progressive format, wherein said second 3D video progressive format comprises a high-definition multimedia interface (HDMI) 3D video format.

2. The method according to claim 1, wherein said second 3D video progressive format comprises side-by-side (half) 1080p24 format, side-by-side (half) 720p60 format, side-by-side (half) 720p50 format, top-and-bottom (half) 1080p24 format, top-and-bottom (half) 720p60 format, top-and-bottom (half) 720p50 format, frame packing 1080p24 format, frame packing 720p60 format and/or frame packing 720p50 format.

3. The method according to claim 1, comprising determining when said 3D video receiver is operating in an electronic program guide (EPG) mode or in a graphics over video mode.

4. The method according to claim 3, comprising:
blending said generated 3D video frame having said second 3D video progressive format with graphics when said 3D video receiver is operating in said EPG mode or in said graphics over video mode; and
when said graphics comprises 3D graphics, adjusting a depth of said 3D graphics and/or a depth of said generated 3D video frame having said second 3D video progressive format coordinately for a blended frame to provide better overall depth of said blended frame.

5. The method according to claim 1, comprising scaling said decompressed 3D video frame having said first 3D video progressive format, which comprises a 24 Hz frame rate, to generate said 3D video frame having said second 3D video progressive format, which comprises a 24 Hz frame rate.

6. The method according to claim 5, comprising converting said generated 3D video frame having said second 3D video progressive format to generate a 3D video frame having a 3D video interlaced format by performing a pulldown.

7. The method according to claim 5, comprising converting said generated 3D video frame having said second 3D video progressive format to generate a 3D video frame having a 3D video interlaced format, which comprises a 60 Hz field rate, by performing a 3:2 pulldown.

8. The method according to claim 5, comprising converting said generated 3D video frame having said second 3D video progressive format to generate a 3D video frame having a 3D video interlaced format, which comprises a 50 Hz field rate, by performing a 2:2 pulldown.

9. The method according to claim 1, comprising scaling said decompressed 3D video frame having said first 3D video progressive format, which comprises a 50 Hz frame rate, to generate said 3D video frame having said second 3D video progressive format, which comprises a 50 Hz frame rate.

10. The method according to claim 1, comprising frame-rate upconverting said generated 3D video frame having said second 3D video progressive format, which comprises a 50 Hz frame rate, to generate a 3D video frame having a third 3D video progressive format, which comprises a 60 Hz frame rate.

11. A system for processing video, the system comprising:
one or more processors and/or circuits for use in a 3-dimensional (3D) video receiver, said one or more processors and/or circuits being operable to:
scale a decompressed 3D video frame having a first 3D video progressive format to generate a 3D video frame having a second 3D video progressive format, wherein said second 3D video progressive format comprises a high-definition multimedia interface (HDMI) 3D video format.

12. The system according to claim 11, wherein said second 3D video progressive format comprises side-by-side (half) 1080p24 format, side-by-side (half) 720p60 format, side-by-side (half) 720p50 format, top-and-bottom (half) 1080p24 format, top-and-bottom (half) 720p60 format, top-and-bottom (half) 720p50 format, frame packing 1080p24 format, frame packing 720p60 format and/or frame packing 720p50 format.

13. The system according to claim 11, wherein said one or more processors and/or circuits are operable to determine when said 3D video receiver is operating in an electronic program guide (EPG) mode or in a graphics over video mode.

14. The system according to claim 13, wherein said one or more processors and/or circuits are operable to:
blend said generated 3D video frame having said second 3D video progressive format with graphics when said 3D video receiver is operating in said EPG mode or in said graphics over video mode; and
when said graphics comprises 3D graphics, adjust a depth of said 3D graphics and/or a depth of said generated 3D video frame having said second 3D video progressive format coordinately for a blended frame to provide better overall depth of said blended frame.

15. The system according to claim 11, wherein said one or more processors and/or circuits are operable to scale said decompressed 3D video frame having said first 3D video progressive format, which comprises a 24 Hz frame rate, to generate said 3D video frame having said second 3D video progressive format, which comprises a 24 Hz frame rate.

16. The system according to claim 15, wherein said one or more processors and/or circuits are operable to convert said generated 3D video frame having said second 3D video progressive format to generate a 3D video frame having a 3D video interlaced format by performing a pulldown.

17. The system according to claim 15, wherein said one or more processors and/or circuits are operable to convert said generated 3D video frame having said second 3D video progressive format to generate a 3D video frame having a 3D video interlaced format, which comprises a 60 Hz field rate, by performing a 3:2 pulldown.

18. The system according to claim 15, wherein said one or more processors and/or circuits are operable to convert said generated 3D video frame having said second 3D video progressive format to generate a 3D video frame having a 3D video interlaced format, which comprises a 50 Hz field rate, by performing a 2:2 pulldown.

19. The system according to claim 11, wherein said one or more processors and/or circuits are operable to scale said decompressed 3D video frame having said first 3D video progressive format, which comprises a 50 Hz frame rate, to generate said 3D video frame having said second 3D video progressive format, which comprises a 50 Hz frame rate.

20. The system according to claim 11, wherein said one or more processors and/or circuits are operable to frame-rate upconvert said generated 3D video frame having said second 3D video progressive format, which comprises a 50 Hz frame rate, to generate a 3D video frame having a third 3D video progressive format, which comprises a 60 Hz frame rate.
